(19) United States
(12) Patent Application Publication
(10) Pub. No.: US 2023/0164472 A1
(43) Pub. Date: May 25, 2023

(54) EXTENDED EARTIPS

(71) Applicant: John P. Keady, Fairfax Station, VA (US)

(72) Inventor: John P. Keady, Fairfax Station, VA (US)

(73) Assignee: HEAR LLC, Fairfax Station, VA (US)

(21) Appl. No.: 17/993,828

(22) Filed: Nov. 23, 2022

Related U.S. Application Data
(60) Provisional application No. 63/248,601, filed on Nov. 23, 2021.

(51) Int. Cl. H04R 1/10

(52) U.S. Cl. CPC H04R 1/1016; H04R 2460/09

(57) ABSTRACT

At least one exemplary embodiment is directed to an eartip or earplug configured to inserted in an ear canal of a user. The eartip or earplug is configured to occlude or partially occlude the ear canal of the user. The eartip or earplug includes a projected tip with various support structures designed to provide enhanced stability, comfort, and/or firmer insertion.

### CROSS-REFERENCE TO RELATED APPLICATIONS

This application is a non provisional of and claims priority to U.S. Pat. App. No. 63/248,601, filed 23 Nov. 2021, the disclosure of all of which are incorporated herein by reference in their entirety.

### FIELD OF THE INVENTION

The present invention relates to devices that modify acoustic attenuation and reflection, and more particularly, though not exclusively, eartips that can be inserted into an ear canal.

### BACKGROUND OF THE INVENTION

One of the current issues with hearing protection and hearing assistance systems is stability and comfort. A stent portion of an eartip typically attaches to a protrusion of an earphone, the stent having an acoustic channel. A tip portion, which contacts the ear canal of a user, is attached to the stent. Conventional eartips do not have a tip portion that extends beyond the end of the stent. Thus a conventional tip portion can be limited to the extent of insertion into a user's ear canal, and thus limited to retention contact surface and stability.

An eartip is needed that can position the contact portion beyond the extent of the stent.

### SUMMARY

An exemplary embodiment is directed to an eartip comprising: a stent; a tip contact portion; and a tip support, wherein the tip support is connected between the stent and the tip contact portion, wherein the tip contact portion has a contact portion distal tip end that extents beyond a stent distal end, and wherein the tip support separates an interior of the eartip into a forward cavity and a rearward cavity.

The tip support can be a sweep forward tip support, a sweep back tip support, a horizontal tip support or a hybrid tip support including at least two of a sweep forward support, a sweep back support, or a horizontal support or a combination thereof.

Where the distance between the contact portion distal tip end and the a stent distal end can be greater than 2 mm and less than 10 mm.

Where the stent can be configured to include a recess, wherein the recess is configured to fit an earphone protrusion. Where the cross section can be circular or oval. Where the eartip can be composed of a material that has a shore A between 5 and 70, and where various parts of the eartips can be composed of different materials or materials with different durometers (e.g., Shore A) values.

### BRIEF DESCRIPTION OF THE DRAWINGS

Exemplary embodiments of present invention will become more fully understood from the detailed description and the accompanying drawings, wherein:

FIG. 1 illustrates a cartilaginous region and a bony region of an ear canal;

FIG. 2 illustrates general physiology of an ear;

FIG. 3 is a schematic diagram of a system for utilizing eartips according to an embodiment of the present disclosure;

FIG. 4 is a schematic diagram of a machine in the form of a computer system within which a set of instructions, when executed, may cause the machine to perform any one or more of the methodologies or operations of the systems and methods for utilizing an eartip according to embodiments of the present disclosure;

FIG. 5 illustrates a molded eartip prior to folding back to form eartip;

FIG. 6 illustrates a cut away of the eartip in FIG. 5;

FIG. 7 illustrates a cut away of a final eartip with a folded edge over a ridge;

FIG. 8 illustrates a cut away of a final eartip with a folded edge pressing up against a ridge;

FIG. 9 illustrates a back or anti-distal view of a circular cross sectional eartip formed by folding the edge up against eth ridge;

FIG. 10 illustrates a side view of the eartip of FIG. 9;

FIG. 11 illustrates a cut away of an earphone with a conventional eartip attached;

FIG. 12 illustrates an oval cross-section eartip;

FIG. 13 illustrates a cut away of the eartip of FIG. 12;

FIG. 14 illustrates a cross-section of a sweep back support eartip;

FIG. 15 illustrates a cross-section of a sweep forward support eartip;

FIG. 16 illustrates a cross-section of a horizontal support eartip; and

FIG. 17 illustrates a cross-section of a hybrid support eartip.

### DETAILED DESCRIPTION OF EXEMPLARY EMBODIMENTS

The following description of exemplary embodiment(s) is merely illustrative in nature and is in no way intended to limit the invention, its application, or uses.

Exemplary embodiments are directed to or can be operatively used on various passive earplugs for hearing protection or electronic wired or wireless earpiece devices (e.g., hearing aids, ear monitors, earbuds, headphones, ear terminal, behind the ear devices or other acoustic devices as known by one of ordinary skill, and equivalents). For example, the earpieces can be without transducers (for a noise attenuation application in a hearing protective earplug) or one or more transducers (e.g. ambient sound microphone (ASM), ear canal microphone (ECM), ear canal receiver (ECR)) for monitoring/providing sound. In all of the examples illustrated and discussed herein, any specific values should be interpreted to be illustrative only and non-limiting. Thus, other examples of the exemplary embodiments could have different values.

Processes, techniques, apparatus, and materials as known by one of ordinary skill in the art may not be discussed in detail but are intended to be part of the enabling description where appropriate. For example specific materials may not be listed for achieving each of the targeted properties discussed, however one of ordinary skill would be able, without undo experimentation, to determine the materials needed given the enabling disclosure herein.

Notice that similar reference numerals and letters refer to similar items in the following figures, and thus once an item is defined in one figure, it may not be discussed or further defined in the following figures. Processes, techniques, apparatus, and materials as known by one of ordinary skill in the relevant art may not be discussed in detail but are intended to be part of the enabling description where appropriate.

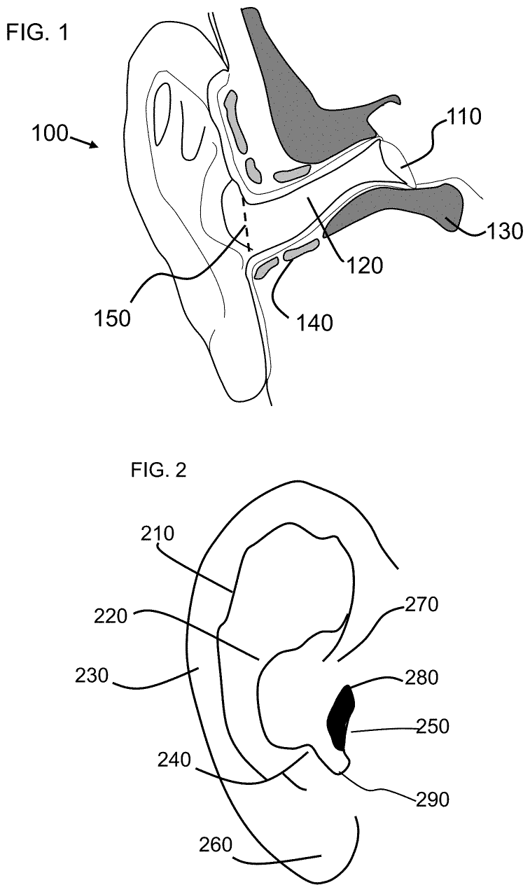

FIG. 1 illustrates a generic cross section of an ear canal 100, including a cartilaginous region 140 and a bony region 130 of an ear canal 120. The entrance of the ear canal 120 is referred to as the aperture 150 and defines a first end of the ear canal while the tympanic membrane 110 defines the other end of the ear canal 120.

FIG. 2 illustrates general outer physiology of an ear, which includes a, auricle tubercle 210, the antihelix 220, the helix 230, the antitragus 240, tragus 250, lobule of ear 260, crus of helix 270, anterior notch 280, and intertragic incisures 290.

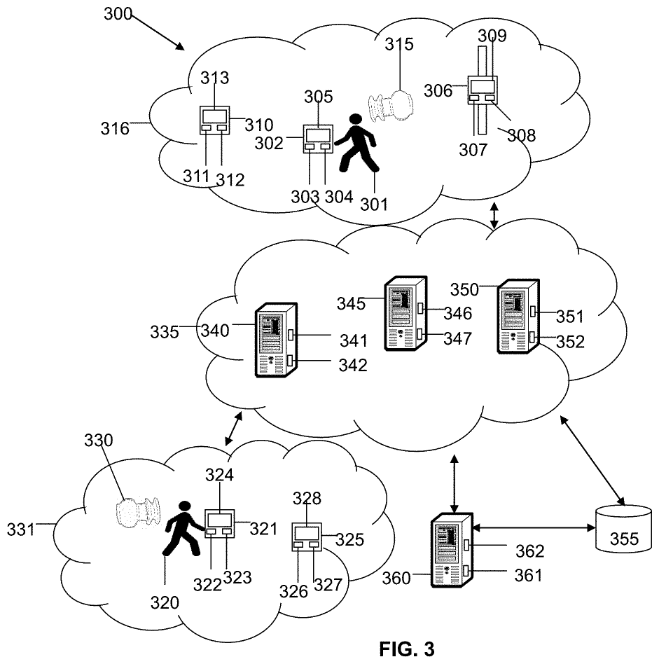

As shown in FIG. 3, a system 300 and methods for utilizing eartips and/or earphone devices are disclosed.

The system 300 may be configured to support, but is not limited to supporting, data and content services, audio processing applications and services, audio output and/or input applications and services, applications and services for transmitting and receiving audio content, authentication applications and services, computing applications and services, cloud computing services, internet services, satellite services, telephone services, software as a service (SaaS) applications, platform-as-a-service (PaaS) applications, gaming applications and services, social media applications and services, productivity applications and services, voice-over-internet protocol (VoIP) applications and services, speech-to-text translation applications and services, interactive voice applications and services, mobile applications and services, and any other computing applications and services. The system may include a first user 301, who may utilize a first user device 302 to access data, content, and applications, or to perform a variety of other tasks and functions. As an example, the first user 301 may utilize first user device 302 to access an application (e.g. a browser or a mobile application) executing on the first user device 302 that may be utilized to access web pages, data, and content associated with the system 300. In certain embodiments, the first user 301 may be any type of user that may potentially desire to listen to audio content, such as from, but not limited to, a music playlist accessible via the first user device 302, a telephone call that the first user 301 is participating in, audio content occurring in an environment in proximity to the first user 301, any other type of audio content, or a combination thereof. For example, the first user 301 may be an individual that may be participating in a telephone call with another user, such as second user 320.

The first user device 302 utilized by the first user 301 may include a memory 303 that includes instructions, and a processor 304 that executes the instructions from the memory 303 to perform the various operations that are performed by the first user device 302. In certain embodiments, the processor 304 may be hardware, software, or a combination thereof. The first user device 302 may also include an interface 305 (e.g. screen, monitor, graphical user interface, etc.) that may enable the first user 301 to interact with various applications executing on the first user device 302, to interact with various applications executing within the system 300, and to interact with the system 300 itself. In certain embodiments, the first user device 302 may include any number of transducers, such as, but not limited to, microphones, speakers, any type of audio-based transducer, any type of transducer, or a combination thereof. In certain embodiments, the first user device 302 may be a computer, a laptop, a tablet device, a phablet, a server, a mobile device, a smartphone, a smart watch, and/or any other type of computing device. Illustratively, the first user device 302 is shown as a mobile device in FIG. 3. The first user device 302 may also include a global positioning system (GPS), which may include a GPS receiver and any other necessary components for enabling GPS functionality, accelerometers, gyroscopes, sensors, and any other componentry suitable for a mobile device.

In addition to using first user device 302, the first user 301 may also utilize and/or have access to a second user device 306 and a third user device 310. As with first user device 302, the first user 301 may utilize the second and third user devices 306, 310 to transmit signals to access various online services and content. The second user device 306 may include a memory 307 that includes instructions, and a processor 308 that executes the instructions from the memory 307 to perform the various operations that are performed by the second user device 306. In certain embodiments, the processor 308 may be hardware, software, or a combination thereof. The second user device 306 may also include an interface 309 that may enable the first user 301 to interact with various applications executing on the second user device 306 and to interact with the system 300. In certain embodiments, the second user device 306 may include any number of transducers, such as, but not limited to, microphones, speakers, any type of audio-based transducer, any type of transducer, or a combination thereof. In certain embodiments, the second user device 306 may be and/or may include a computer, any type of sensor, a laptop, a set-top-box, a tablet device, a phablet, a server, a mobile device, a smartphone, a smart watch, and/or any other type of computing device. Illustratively, the second user device 302 is shown as a smart watch device in FIG. 3.

The third user device 310 may include a memory 311 that includes instructions, and a processor 312 that executes the instructions from the memory 311 to perform the various operations that are performed by the third user device 310. In certain embodiments, the processor 312 may be hardware, software, or a combination thereof. The third user device 310 may also include an interface 313 that may enable the first user 301 to interact with various applications executing on the second user device 306 and to interact with the system 300. In certain embodiments, the third user device 310 may include any number of transducers, such as, but not limited to, microphones, speakers, any type of audio-based transducer, any type of transducer, or a combination thereof. In certain embodiments, the third user device 310 may be and/or may include a computer, any type of sensor, a laptop, a set-top-box, a tablet device, a phablet, a server, a mobile device, a smartphone, a smart watch, and/or any other type of computing device. Illustratively, the third user device 310 is shown as a smart watch device in FIG. 3.

The first, second, and/or third user devices 302, 306, 330 may belong to and/or form a communications network 316. In certain embodiments, the communications network 316 may be a local, mesh, or other network that facilitates communications among the first, second, and/or third user devices 302, 306, 310 and/or any other devices, programs, and/or networks of system 300 or outside system 300. In certain embodiments, the communications network 316 may be formed between the first, second, and third user devices 302, 306, 310 through the use of any type of wireless or other protocol and/or technology. For example, the first, second, and third user devices 302, 306, 310 may communicate with one another in the communications network 316, such as by utilizing Bluetooth Low Energy (BLE), classic Bluetooth, ZigBee, cellular, NFC, Wi-Fi, Z-Wave, ANT+, IEEE 802.15.4, IEEE 802.22, ISA100a, infrared, ISM band, RFID, UWB, Wireless HD, Wireless USB, any other protocol and/or wireless technology, satellite, fiber, or any combination thereof. Notably, the communications network 316 may be configured to communicatively link with and/or communicate with any other network of the system 300 and/or outside the system 300.

The system 300 may also include an earphone device 315, which the first user 301 may utilize to hear and/or audition audio content, transmit audio content, receive audio content, experience any type of content, process audio content, adjust audio content, store audio content, perform any type of operation with respect to audio content, or a combination thereof. The earphone device 315 may be an earpiece, a hearing aid, an ear monitor, an ear terminal, a behind-the-ear device, any type of acoustic device, or a combination thereof. The earphone device 315 may include any type of component utilized for any type of earpiece. In certain embodiments, the earphone device 315 may include any number of ambient sound microphones that may be configured to capture and/or measure ambient sounds and/or audio content occurring in an environment that the earphone device 315 is present in and/or is proximate to. In certain embodiments, the ambient sound microphones may be placed at a location or locations on the earphone device 315 that are conducive to capturing and measuring ambient sounds occurring in the environment. For example, the ambient sound microphones may be positioned in proximity to a distal end (e.g. the end of the earphone device 315 that is not inserted into the first user's 301 ear) of the earphone device 315 such that the ambient sound microphones are in an optimal position to capture ambient or other sounds occurring in the environment. In certain embodiments, the earphone device 315 may include any number of ear canal microphones, which may be configured to capture and/or measure sounds occurring in an ear canal of the first user 301 or other user wearing the earphone device 315. In certain embodiments, the ear canal microphones may be positioned in proximity to a proximal end (e.g. the end of the earphone device 315 that is inserted into the first user's 301 ear) of the earphone device 315 such that sounds occurring in the ear canal of the first user 301 may be captured more readily.

The earphone device 315 may also include any number of transceivers, which may be configured transmit signals to and/or receive signals from any of the devices in the system 300. In certain embodiments, a transceiver of the earphone device 315 may facilitate wireless connections and/or transmissions between the earphone device 315 and any device in the system 300, such as, but not limited to, the first user device 302, the second user device 306, the third user device 310, the fourth user device 321, the fifth user device 325, the earphone device 330, the servers 340, 345, 350, 360, and the database 355. The earphone device 315 may also include any number of memories for storing content and/or instructions, processors that execute the instructions from the memories to perform the operations for the earphone device 315, and/or any type integrated circuit for facilitating the operation of the earphone device 315. In certain embodiments, the processors may comprise, hardware, software, or a combination of hardware and software. The earphone device 315 may also include one or more ear canal receivers, which may be speakers for outputting sound into the ear canal of the first user 301. The ear canal receivers may output sounds obtained via the ear canal microphones, ambient sound microphones, any of the devices in the system 300, from a storage device of the earphone device 315, or any combination thereof.

The ear canal receivers, ear canal microphones, transceivers, memories, processors, integrated circuits, and/or ear canal receivers may be affixed to an electronics package that includes a flexible electronics board. The earphone device 315 may include an electronics packaging housing that may house the ambient sound microphones, ear canal microphones, ear canal receivers (i.e., speakers), electronics supporting the functionality of the microphones and/or receivers, transceivers for receiving and/or transmitting signals, power sources (e.g., batteries and the like), any circuitry facilitating the operation of the earphone device 315, or any combination thereof. The electronics package including the flexible electronics board may be housed within the electronics packaging housing to form an electronics packaging unit. The earphone device 315 may further include an earphone housing, which may include receptacles, openings, and/or keyed recesses for connecting the earphone housing to the electronics packaging housing and/or the electronics package. For example, nozzles of the electronics packaging housing may be inserted into one or more keyed recesses of the earphone housing so as to connect and secure the earphone housing to the electronics packaging housing. When the earphone housing is connected to the electronics packaging housing, the combination of the earphone housing and the electronics packaging housing may form the earphone device 315. The earphone device 315 may further include a cap for securing the electronics packaging housing, the earphone housing, and the electronics package together to form the earphone device 315.

In certain embodiments, the earphone device 315 may be configured to have any number of changeable tips, which may be utilized to facilitate the insertion of the earphone device 315 into an ear aperture of an ear of the first user 301, secure the earphone device 315 within the ear canal of an ear of the first user 301, and/or to isolate sound within the ear canal of the first user 301. The tips may be foam tips, which may be affixed onto an end of the earphone housing of the earphone device 315, such as onto a stent and/or attachment mechanism of the earphone housing. In certain embodiments, the tips may be any type of eartip as disclosed and described in the present disclosure. The eartips as disclosed in the present disclosure may be configured to facilitate distributed reduced contact force, sound isolation for sound in the ear canal of the first user 301 (i.e. between the ambient environment and the ear canal environment within an ear of the first user 301), mold into a variety of forms and/or positions, encapsulate volumes upon insertion into an ear aperture of the first user 301, have a pressure adjusting design, facilitate notched stent retention (i.e. on a stent of the earphone housing), facilitate stent insertion into an ear canal of the first user 301 via an ear aperture of the first user 301, or any combination thereof. In certain embodiments, the eartip may be designed to provide sound isolation capability that is at least as effective as conventional foam and/or flange tips. Notably, the eartips may be manufactured and configured to be made in any desired size specifications and/or materials, and may be tailored to each individual user, such as first user 301. In contrast to conventional foam or flange tips, an eartip according to the present disclosure may be adjusted for size without having to substitute the eartip with another eartip, may have an EPA NRR rating of NRR=18, may have a unique flatter high frequency attenuation profile so as to maintain audio quality, may have ease of manufacturability, and may be designed to distribute contact force and minimize radial force against a user's ear canal walls when positioned in a user's ear canal. Additionally, an eartip according to the present disclosure may be made of a non-porous material that is not closed cell foam or open cell foam.

In certain embodiments, the eartip may be designed so that the earphone device's 315 retention force on the ear canal walls of the first user 301 may be distributed over a larger area than traditional foam or flange tips allow, thereby reducing the pressure on the ear canal walls of the first user 10. Unlike foam tips, which primarily provide a restoring radial force that exerts pressure against the ear canal walls of a user, the eartip is designed to move both radially and axially, which allows for more give and redistribution of contact over a larger area, and, thus, decreases the retention pressure. As a result, this allows for increased comfort for the user and allows the user to utilize the eartip for an extended period of time when compared to traditional foam and/or flange tips. In certain embodiments, the eartip utilized with the earphone device 315 may be configured to encapsulate a volume of gas and/or liquid. In either case (i.e. gas or liquid), the bulk of sound isolation provided by the eartip is achieved through the reflection of ambient sound waves so that the encapsulated volume can be low mass. In certain embodiments, portions of the eartip may encapsulate a volume with the ability to release volume when pressed upon without having to incorporate complicated valves. The encapsulated volume may be achieved by the ear canal wall pressing radially and/or axially against the outer surfaces of the eartip, which may force the outer portion of the eartip to seal with the inner portion of the eartip. In certain embodiments, the inner portion of the eartip may be small than the outer diameter of the stent of the earphone housing upon which the eartip is placed so that upon insertion of the eartip on the stent, the inner portion stretches outward to meet the outer surface of the eartip, which further facilitates the sealing of the ear canal of the first user 301.

In certain embodiments, the stent of the eartip, over which the eartip is placed, may be designed to have a smaller diameter front end and a larger diameter middle section to promote retention of the eartip on the stent itself. In certain embodiments, a portion of the eartip may have an inner core diameter that is smaller than the stent outer diameter so that the eartip provides radial compression upon the stent so as to enhance sealing and to add friction to prevent axial slippage within the ear canal of the first user 301. In certain embodiments, an increased mid-section inner core diameter of the eartip may be utilized (i.e., larger than the smaller inner core diameter of the eartip), which may be configured to line up with the mid-section outer diameter of the stent of the earphone housing of the earphone device 315. This may provide axial stability for the earphone device 315, while simultaneously preventing axial slippage from the ear canal of the first user 301. In certain embodiments, the eartip may have an insertion end that has a funnel shape, which aids in inserting the eartip onto the stent of the earphone housing of the earphone device 315.

In certain embodiments, the eartip has a configuration that applies minimal force against the first user's 301 ear canal. Additionally, the eartip can seal the first user's 301 ear canal by providing at least 15 dB of attenuation across frequency. To facilitate manufacturability, the eartip may be molded inverted, thereby allowing inexpensive mass production. Lips of the eartip may then be folded to contact ledges to for the eartip that may be utilized by the first user 301. Sealing and comfort depend upon an accurate fit within the first user's 301 ear canal, and, as a result, eartips according to the present disclosure may be manufactured in several single sizes, and, because of the unique design of the eartips, a single eartip may be adjusted to fit multiple sizes, which minimizes manufacturing costs, while allowing for more flexibility, versatility, and for a greater number of sizes for the eartip. Notably, any of the features of any of the eartips described in the present disclosure may be combined and/or interchanged with any other eartips described in the present disclosure. Furthermore, the shape, size, features and/or functionality of any of the components of the earphone device and/or hearbud housing device described in the present disclosure may be modified for each particular user for the shape and size of each user's ear aperture and/or ear canal, or a combination thereof.

Notably, in experiments conducted using the eartip, the experiments have shown that the eartip allows for similar levels of sound isolation when compared to conventional foam and/or flange tips. For example, experiments have shown that the eartips provided in the present disclosure provided a NRR of 18 with a generally flat high frequency profile. A flat attenuation profile maintains an ambient environment's frequency profile when level reduced by the attenuation, which can be useful in maintaining the quality of ambient speech and music (or other audio content) during the level reduction process.

In further embodiments, the eartip may be configured to have an open configuration prior to insertion onto a stent of the earphone housing and/or the earphone device 315 itself. By having an open configuration, the eartip may be mass produced using conventional molding techniques and/or by utilizing 3D commercial printers. The open configuration of the eartip also facilitates molding, and can be 3D printed, where the open configuration allows for resin removal. For example, resin removal may be achieved by utilizing commercial 3D printers that allow the use of lower durometer materials, such as Stratasys machines and the like. In certain embodiments, since the eartip has an open configuration, which is then sealed, any additional pressure can force encapsulated gas out of the eartip relieving the feedback pressure so as to keep the comfort level for the first user 301 relatively stable.

In addition to the first user 301, the system 300 may include a second user 320, who may utilize a fourth user device 321 to access data, content, and applications, or to perform a variety of other tasks and functions. Much like the first user 301, the second user 320 may be may be any type of user that may potentially desire to listen to audio content, such as from, but not limited to, a storage device of the fourth user device 321, a telephone call that the second user 320 is participating in, audio content occurring in an environment in proximity to the second user 320, any other type of audio content, or a combination thereof. For example, the second user 320 may be an individual that may be listening to songs stored in a playlist that resides on the fourth user device 321. Also, much like the first user 301, the second user 320 may utilize fourth user device 321 to access an application (e.g. a browser or a mobile application) executing on the fourth user device 321 that may be utilized to access web pages, data, and content associated with the system 300. The fourth user device 321 may include a memory 322 that includes instructions, and a processor 323 that executes the instructions from the memory 322 to perform the various operations that are performed by the fourth user device 321. In certain embodiments, the processor 323 may be hardware, software, or a combination thereof. The fourth user device 321 may also include an interface 324 (e.g. a screen, a monitor, a graphical user interface, etc.) that may enable the second user 320 to interact with various applications executing on the fourth user device 321, to interact with various applications executing in the system 300, and to interact with the system 300. In certain embodiments, the fourth user device 321 may include any number of transducers, such as, but not limited to, microphones, speakers, any type of audio-based transducer, any type of transducer, or a combination thereof. In certain embodiments, the fourth user device 321 may be a computer, a laptop, a tablet device, a phablet, a server, a mobile device, a smartphone, a smart watch, and/or any other type of computing device. Illustratively, the fourth user device 321 may be a computing device in FIG. 3. The fourth user device 321 may also include any of the componentry described for first user device 302, the second user device 306, and/or the third user device 310. In certain embodiments, the fourth user device 321 may also include a global positioning system (GPS), which may include a GPS receiver and any other necessary components for enabling GPS functionality, accelerometers, gyroscopes, sensors, and any other componentry suitable for a computing device.

In addition to using fourth user device 321, the second user 320 may also utilize and/or have access to a fifth user device 325. As with fourth user device 321, the second user 320 may utilize the fourth and fifth user devices 321, 325 to transmit signals to access various online services and content. The fifth user device 325 may include a memory 326 that includes instructions, and a processor 327 that executes the instructions from the memory 326 to perform the various operations that are performed by the fifth user device 325. In certain embodiments, the processor 327 may be hardware, software, or a combination thereof. The fifth user device 325 may also include an interface 328 that may enable the second user 320 to interact with various applications executing on the fifth user device 325 and to interact with the system 300. In certain embodiments, the fifth user device 325 may include any number of transducers, such as, but not limited to, microphones, speakers, any type of audio-based transducer, any type of transducer, or a combination thereof. In certain embodiments, the fifth user device 325 may be and/or may include a computer, any type of sensor, a laptop, a set-top-box, a tablet device, a phablet, a server, a mobile device, a smartphone, a smart watch, and/or any other type of computing device. Illustratively, the fifth user device 325 is shown as a tablet device in FIG. 3.

The fourth and fifth user devices 321, 325 may belong to and/or form a communications network 331. In certain embodiments, the communications network 331 may be a local, mesh, or other network that facilitates communications between the fourth and fifth user devices 321, 325, and/or any other devices, programs, and/or networks of system 300 or outside system 300. In certain embodiments, the communications network 331 may be formed between the fourth and fifth user devices 321, 325 through the use of any type of wireless or other protocol and/or technology. For example, the fourth and fifth user devices 321, 325 may communicate with one another in the communications network 316, such as by utilizing BLE, classic Bluetooth, ZigBee, cellular, NFC, Wi-Fi, Z-Wave, ANT+, IEEE 802.15.4, IEEE 802.22, ISA100a, infrared, ISM band, RFID, UWB, Wireless HD, Wireless USB, any other protocol and/or wireless technology, satellite, fiber, or any combination thereof. Notably, the communications network 331 may be configured to communicatively link with and/or communicate with any other network of the system 300 and/or outside the system 300.

Much like first user 301, the second user 320 may have his or her own earphone device 330. The earphone device 330 may be utilized by the second user 320 to hear and/or audition audio content, transmit audio content, receive audio content, experience any type of content, process audio content, adjust audio content, store audio content, perform any type of operation with respect to audio content, or a combination thereof. The earphone device 330 may be an earpiece, a hearing aid, an ear monitor, an ear terminal, a behind-the-ear device, any type of acoustic device, or a combination thereof. The earphone device 330 may include any type of component utilized for any type of earpiece, and may include any of the features, functionality and/or components described and/or usable with earphone device 315. For example, earphone device 330 may include any number of transceivers, ear canal microphones, ambient sound microphones, processors, memories, housings, eartips, foam tips, flanges, any other component, or any combination thereof.

In certain embodiments, the first, second, third, fourth, and/or fifth user devices 302, 306, 310, 321, 325 and/or earphone devices 315, 330 may have any number of software applications and/or application services stored and/or accessible thereon. For example, the first and second user devices 302, 311 may include applications for processing audio content, applications for playing, editing, transmitting, and/or receiving audio content, streaming media applications, speech-to-text translation applications, cloud-based applications, search engine applications, natural language processing applications, database applications, algorithmic applications, phone-based applications, product-ordering applications, business applications, e-commerce applications, media streaming applications, content-based applications, database applications, gaming applications, internet-based applications, browser applications, mobile applications, service-based applications, productivity applications, video applications, music applications, social media applications, presentation applications, any other type of applications, any types of application services, or a combination thereof. In certain embodiments, the software applications and services may include one or more graphical user interfaces so as to enable the first and second users 301, 320 to readily interact with the software applications. The software applications and services may also be utilized by the first and second users 301, 320 to interact with any device in the system 300, any network in the system 300 (e.g. communications networks 316, 331, 335), or any combination thereof. For example, the software applications executing on the first, second, third, fourth, and/or fifth user devices 302, 306, 310, 321, 325 and/or earphone devices 315, 330 may be applications for receiving data, applications for storing data, applications for auditioning, editing, storing and/or processing audio content, applications for receiving demographic and preference information, applications for transforming data, applications for executing mathematical algorithms, applications for generating and transmitting electronic messages, applications for generating and transmitting various types of content, any other type of applications, or a combination thereof. In certain embodiments, the first, second, third, fourth, and/or fifth user devices 302, 306, 310, 321, 325 and/or earphone devices 315, 330 may include associated telephone numbers, internet protocol addresses, device identities, or any other identifiers to uniquely identify the first, second, third, fourth, and/or fifth user devices 302, 306, 310, 321, 325 and/or earphone devices 315, 330 and/or the first and second users 301, 320. In certain embodiments, location information corresponding to the first, second, third, fourth, and/or fifth user devices 302, 306, 310, 321, 325 and/or earphone devices 315, 330 may be obtained based on the internet protocol addresses, by receiving a signal from the first, second, third, fourth, and/or fifth user devices 302, 306, 310, 321, 325 and/or earphone devices 315, 330 or based on profile information corresponding to the first, second, third, fourth, and/or fifth user devices 302, 306, 310, 321, 325 and/or earphone devices 315, 330.

The system 300 may also include a communications network 335. The communications network 335 may be under the control of a service provider, the first and/or second users 301, 320, any other designated user, or a combination thereof. The communications network 335 of the system 300 may be configured to link each of the devices in the system 300 to one another. For example, the communications network 335 may be utilized by the first user device 302 to connect with other devices within or outside communications network 335. Additionally, the communications network 335 may be configured to transmit, generate, and receive any information and data traversing the system 300. In certain embodiments, the communications network 335 may include any number of servers, databases, or other componentry. The communications network 335 may also include and be connected to a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 340, 345, and 350 are shown as being included within communications network 335. In certain embodiments, the communications network 335 may be part of a single autonomous system that is located in a particular geographic region, or be part of multiple autonomous systems that span several geographic regions.

Notably, the functionality of the system 300 may be supported and executed by using any combination of the servers 340, 345, 350, and 360. The servers 340, 345, and 350 may reside in communications network 335, however, in certain embodiments, the servers 340, 345, 350 may reside outside communications network 335. The servers 340, 345, and 350 may provide and serve as a server service that performs the various operations and functions provided by the system 300. In certain embodiments, the server 340 may include a memory 341 that includes instructions, and a processor 342 that executes the instructions from the memory 341 to perform various operations that are performed by the server 340. The processor 342 may be hardware, software, or a combination thereof. Similarly, the server 345 may include a memory 346 that includes instructions, and a processor 347 that executes the instructions from the memory 346 to perform the various operations that are performed by the server 345. Furthermore, the server 350 may include a memory 351 that includes instructions, and a processor 352 that executes the instructions from the memory 351 to perform the various operations that are performed by the server 350. In certain embodiments, the servers 340, 345, 350, and 360 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 340, 345, 350 may be communicatively linked to the communications network 335, the communications network 316, the communications network 331, any network, any device in the system 300, any program in the system 300, or any combination thereof.

The database 355 of the system 300 may be utilized to store and relay information that traverses the system 300, cache content that traverses the system 300, store data about each of the devices in the system 300 and perform any other typical functions of a database. In certain embodiments, the database 355 may be connected to or reside within the communications network 335, the communications network 316, the communications network 331, any other network, or a combination thereof. In certain embodiments, the database 355 may serve as a central repository for any information associated with any of the devices and information associated with the system 300. Furthermore, the database 355 may include a processor and memory or be connected to a processor and memory to perform the various operation associated with the database 355. In certain embodiments, the database 355 may be connected to the earphone devices 315, 330, the servers 340, 345, 350, 360, the first user device 302, the second user device 306, the third user device 310, the fourth user device 321, the fifth user device 325, any devices in the system 300, any other device, any network, or any combination thereof.

The database 355 may also store information and metadata obtained from the system 300, store metadata and other information associated with the first and second users 301, 320, store user profiles associated with the first and second users 301, 320, store device profiles associated with any device in the system 300, store communications traversing the system 300, store user preferences, store information associated with any device or signal in the system 300, store information relating to patterns of usage relating to the first, second, third, fourth, and fifth user devices 302, 306, 310, 321, 325, store audio content associated with the first, second, third, fourth, and fifth user devices 302, 306, 310, 321, 325 and/or earphone devices 315, 330, store audio content and/or information associated with the audio content that is captured by the ambient sound microphones, store audio content and/or information associated with audio content that is captured by ear canal microphones, store any information obtained from any of the networks in the system 300, store audio content and/or information associated with audio content that is outputted by ear canal receivers of the system 300, store any information and/or signals transmitted and/or received by transceivers of the system 300, store any device and/or capability specifications relating to the earphone devices 315, 330, store historical data associated with the first and second users 301, 315, store information relating to the size (e.g. depth, height, width, curvatures, etc.) and/or shape of the first and/or second user's 301, 320 ear canals and/or ears, store information identifying and or describing any eartip utilized with the earphone devices 301, 315, store device characteristics for any of the devices in the system 300, store information relating to any devices associated with the first and second users 301, 320, store any information associated with the earphone devices 315, 330, store log on sequences and/or authentication information for accessing any of the devices of the system 300, store information associated with the communications networks 316, 331, store any information generated and/or processed by the system 300, store any of the information disclosed for any of the operations and functions disclosed for the system 300 herewith, store any information traversing the system 300, or any combination thereof. Furthermore, the database 355 may be configured to process queries sent to it by any device in the system 300.

The system 300 may also include a software application, which may be configured to perform and support the operative functions of the system 300, such as the operative functions of the first, second, third, fourth, and fifth user devices 302, 306, 310, 321, 325 and/or the earphone devices 315, 330. In certain embodiments, the application may be a website, a mobile application, a software application, or a combination thereof, which may be made accessible to users utilizing one or more computing devices, such as the first, second, third, fourth, and fifth user devices 302, 306, 310, 321, 325 and/or the earphone devices 315, 330. The application of the system 300 may be accessible via an internet connection established with a browser program or other application executing on the first, second, third, fourth, and fifth user devices 302, 306, 310, 321, 325 and/or the earphone devices 315, 330, a mobile application executing on the first, second, third, fourth, and fifth user devices 302, 306, 310, 321, 325 and/or the earphone devices 315, 330, or through other suitable means. Additionally, the application may allow users and computing devices to create accounts with the application and sign-in to the created accounts with authenticating username and password log-in combinations. The application may include a custom graphical user interface that the first user 301 or second user 320 may interact with by utilizing a browser executing on the first, second, third, fourth, and fifth user devices 302, 306, 310, 321, 325 and/or the earphone devices 315, 330. In certain embodiments, the software application may execute directly as an installed program on the first, second, third, fourth, and fifth user devices 302, 306, 310, 321, 325 and/or the earphone devices 315, 330.

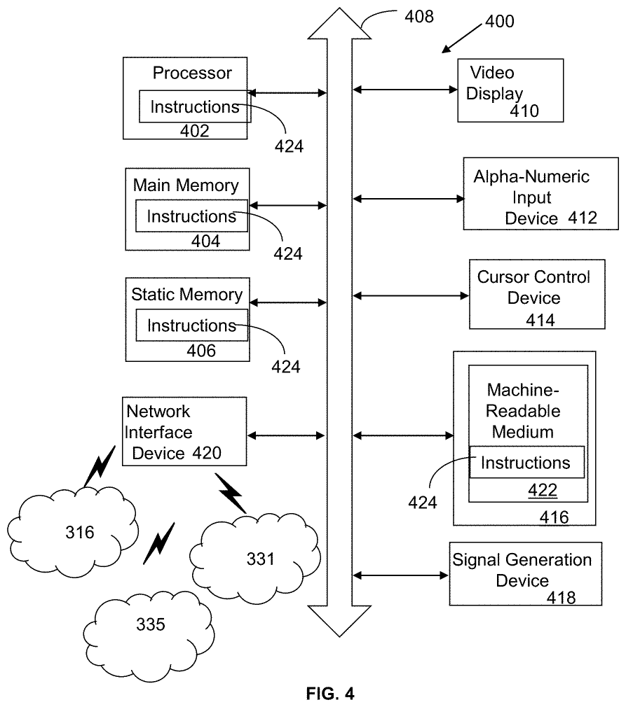

Referring now also to FIG. 4, at least a portion of the methodologies and techniques described with respect to the exemplary embodiments of the system 400 can incorporate a machine, such as, but not limited to, computer system 400, or other computing device within which a set of instructions, when executed, may cause the machine to perform any one or more of the methodologies or functions discussed above. The machine may be configured to facilitate various operations conducted by the system 400. For example, the machine may be configured to, but is not limited to, assist the system 400 by providing processing power to assist with processing loads experienced in the system 400, by providing storage capacity for storing instructions or data traversing the system 400, by providing functionality and/or programs for facilitating the operative functionality of the earphone devices 315, 330, and/or the first, second, third, fourth, and fifth user devices 302, 306, 310, 321, 325 and/or the earphone devices 315, 330, by providing functionality and/or programs for facilitating operation of any of the components of the earphone devices 315, 330 (e.g. ear canal receivers, transceivers, ear canal microphones, ambient sound microphones, or by assisting with any other operations conducted by or within the system 400.

In some embodiments, the machine may operate as a standalone device. In some embodiments, the machine may be connected (e.g., using communications network 335, the communications network 316, the communications network 331, another network, or a combination thereof) to and assist with operations performed by other machines and systems, such as, but not limited to, the first user device 302, the second user device 311, the third user device 310, the fourth user device 321, the fifth user device 325, the earphone device 315, the earphone device 330, the server 340, the server 350, the database 355, the server 360, or any combination thereof. The machine may be connected with any component in the system 400. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410, which may be, but is not limited to, a liquid crystal display (LCD), a flat panel, a solid state display, or a cathode ray tube (CRT). The computer system 400 may include an input device 412, such as, but not limited to, a keyboard, a cursor control device 414, such as, but not limited to, a mouse, a disk drive unit 416, a signal generation device 418, such as, but not limited to, a speaker or remote control, and a network interface device 420.

The disk drive unit 416 may include a machine-readable medium 422 on which is stored one or more sets of instructions 424, such as, but not limited to, software embodying any one or more of the methodologies or functions described herein, including those methods illustrated above. The instructions 424 may also reside, completely or at least partially, within the main memory 404, the static memory 406, or within the processor 402, or a combination thereof, during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 422 containing instructions 424 so that a device connected to the communications network 335, the communications network 316, the communications network 331, another network, or a combination thereof, can send or receive voice, video or data, and communicate over the communications network 335, the communications network 316, the communications network 331, another network, or a combination thereof, using the instructions. The instructions 424 may further be transmitted or received over the communications network 335, another network, or a combination thereof, via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

Note that the stent can be fabricated from various materials (e.g., silicon, urethane, rubber) and can include internal channel (tubes). The stent can also be a multi-lumen (i.e., multi-passageway) stent where the channels/tubes are various lumens of the multi-lumen stent, or solid (e.g., earplug stent). Note that the material of the membrane can have similar or different properties from the stent, and can be composed, as can the stent, of material known by one of ordinary skill in the art of eartip (e.g., flange, foam eartip) manufacturing. Also, the eartip can have a material property between 2 Shore A to 90 Shore A.

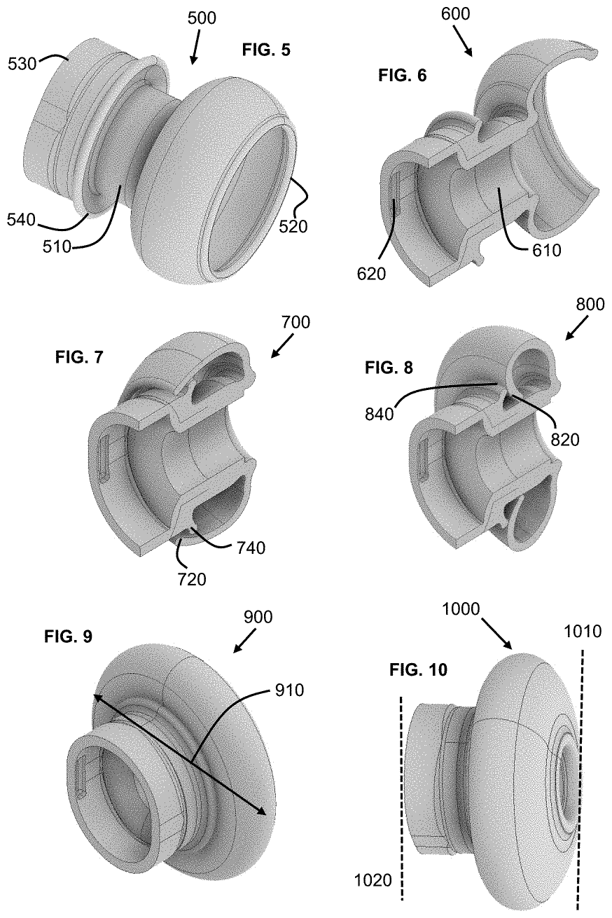

FIG. 5 illustrates a molded eartip prior to folding back to form eartip. The method can include forming a mold of an unfolded shape of an eartip 500, providing or supplying a flexible material to the mold for a threshold time and temperature for curing to form a cured inverted eartip 500, removing the cured inverted eartip and folding the molded distal end 520 over the ridge 540 or against the ridge 540. The unfolded eartip 500 has a stent 510 which can have within an acoustic channel 610 to carry acoustic energy. The eartip 500 can have an ambient end 530 that fits with a protrusion of an earphone. A recess 620 can fit within the protrusion. FIG. 6 illustrates a cut away of the eartip in FIG. 5. The molded eartip can be formed of various flexible materials including, but not limited to, silicone, rubber (including high strength rubber), urethane, synthetic rubber, nitrile rubber, chloroprene rubber, EVA rubber, Quartz fibre, any other suitable material, or a combination thereof.

The Eartip (eartip) can be fabricated by various means, for example injection molding, then sealed with various filler mediums (e.g. gas, liquid, gel), and inserted upon a stent, for example the eartip can have an extension portion that slides over the stent.

For example specific materials may not be listed for achieving each of the targeted properties discussed, however one of ordinary skill would be able, without undo experimentation, to determine the materials and thicknesses needed given the enabling disclosure herein. For example Elastosil™ 30A, 70A, High Strength 1, 2, 3, Moldmaking Rubber (Alumilite™ products), flexible 3D printable material, silicon, urethane, natural and synthetic rubber, high strength rubber, chloroprene rubber, EVA rubber, quartz fiber, can be used; however, any material that can be used within the ear canal can be used for eartips and any material that can be used for earphones (silicon, urethane, rubber, plastic, Elastosil, metal, wood, and the like) can be used in the earphone housing and components thereof. As discussed herein, the eartips can be printed on three dimensional printers while provided the Shore A hardiness discussed herein. Various material can also be used for the EPH, for example tough resin (Form Labs) if printed and any other materials, as mentioned if molded. Typical durometer for the in ear portions can be from shore A of 5-40.

The eartips can be formed as an inverted shape mold as discussed herein. As an example, the inverted mold can be formed as a partial cylindrical sleeve with the shapes and arrangements disclosed herein. Such manufacturing provides great advantages of reduced cost without sacrificing performance of the eartips. As disclosed, the inverted shape mold allows the user to folder over portions of the eartip to use the eartip. Such eartips can provide the performance disclosed herein while being designed to be disposable. For example provide an NRR rating of at lease 5 dB to 35 dB.

FIG. 7 illustrates a cut away of a final eartip 700 with a folded edge (distal end 720) over ridge 740, while FIG. 8 illustrates a cut away of a final eartip 800 with a folded edge where the molded distal end 820 presses up against the ridge 840.

FIG. 9 illustrates a back or anti-distal view of a circular cross sectional eartip formed by folding the edge up against the ridge having a diameter 910 that can range from 3 mm to 25 mm or any other diameter that is needed to seal the targeted orifice (e.g., ear canal).

FIG. 10 illustrates a side view of the eartip of FIG. 9, that has a distal end 1010 and an ambient end 1020.

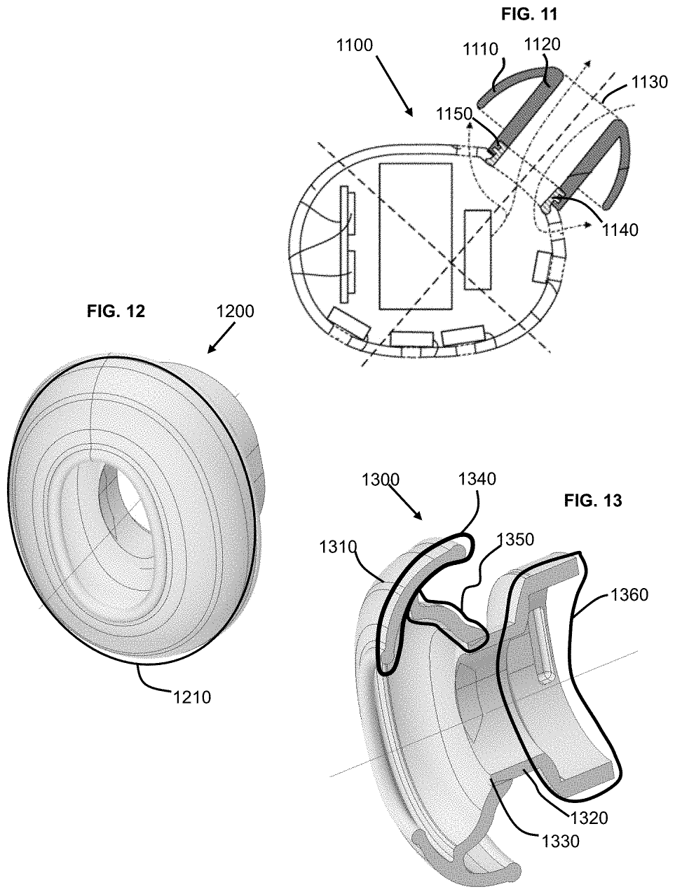

FIG. 11 illustrates a cut away of an earphone 1100 with a conventional eartip attached. The conventional eartip can include: a tip portion 1110, that contacts the wall of the ear canal; a stent 1120 that can include an acoustic channel having a distal end 1130, attaching a recess 1150 into an earphone housing protrusion 1140.

FIG. 12 illustrates an oval cross-section 1210 eartip, although various cross sections are also possible.

FIG. 13 illustrates a cut away of the eartip of FIG. 12. The eartip 1300 has an outer surface 1310 that contacts at least a portion of an ear canal wall which is part of a tip contact portion 1340. The tip contact portion 1340 is supported by the tip support 1350 connected to the stent 1320, which has an internal distal end 1330 similar to the conventional distal end 1130. The eartip 1300 has a tip coupling portion 1360 that can connect to an earphone.

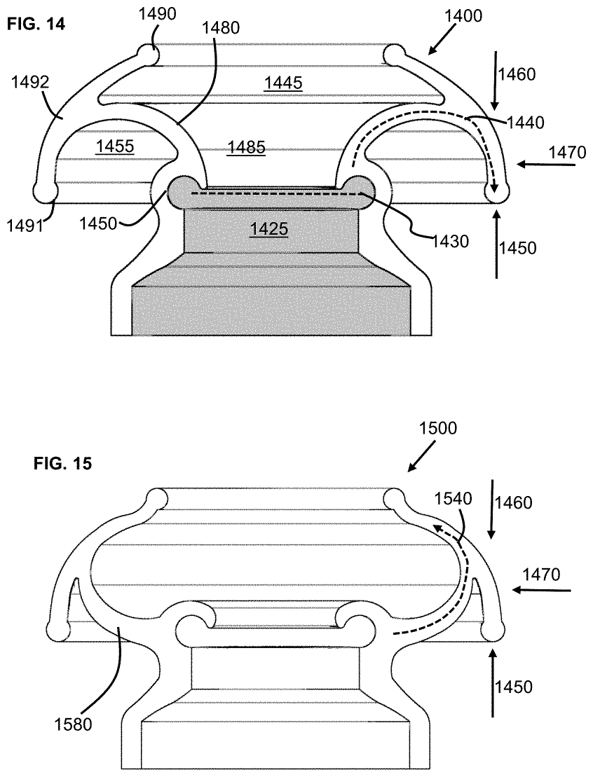

FIG. 14 illustrates a cross-section of a sweep back support eartip 1400. The projected (extended) eartip 1400 has a tip distal end 1490 that is off set (e.g., 0.5 to 20 mm) from the traditional distal end which can be the earphone coupler distal end 1430. The eartip 1400 can have a recess/shape 1450 that fits an earphone's coupler 1425 which is at the earphone coupler distal end 1430. The portion of the eartip 1400 that is designed to potentially contact (e.g., tip contact portion 1492) the ear canal wall lies between the tip distal end 1490 and the tip ambient end 1491. A sweep rearward/back support 1480 can separate the interior of the eartip into the forward cavity 1445 and the rearward cavity 1455, where the forward cavity can extend from an acoustic aperture 1485 from which acoustic energy normally is directed toward the ears of a user. The sweep back support 1480 provides a force 1440 to oppose a removal force 1450, assisting in stability retention of the eartip. The other main force occurring during insertion and removal are the force opposing insertion 1460 (distal force), the force opposing removal 1450 (removal force) and the force exerted on the eartip by the ear canal 1470 (radial force). The sweep back tip support is designed by the arch to oppose the removal force 1450 more so than the insertion force 1460 or the radial force 1470. FIGS. 15, 16, 17 each show various tip support configurations to oppose different forces.

FIG. 15 illustrates a cross-section of a sweep forward support eartip 1500. The sweep forward tip support 1580 is designed to create a force 1540 that opposes the insertion or distal force 1460 more than the other forces. This can be because more rigidity is needed for insertion to avoid the tip crumbling and not proceeding to a further depth of insertion. A further depth of insertion can be useful to provide stability, and to maximize the contact surface, and distributing the retention force amongst a larger surface assists in comfort. Comfort can be equated to pressure exerted on the ear canal wall or force/unit area.

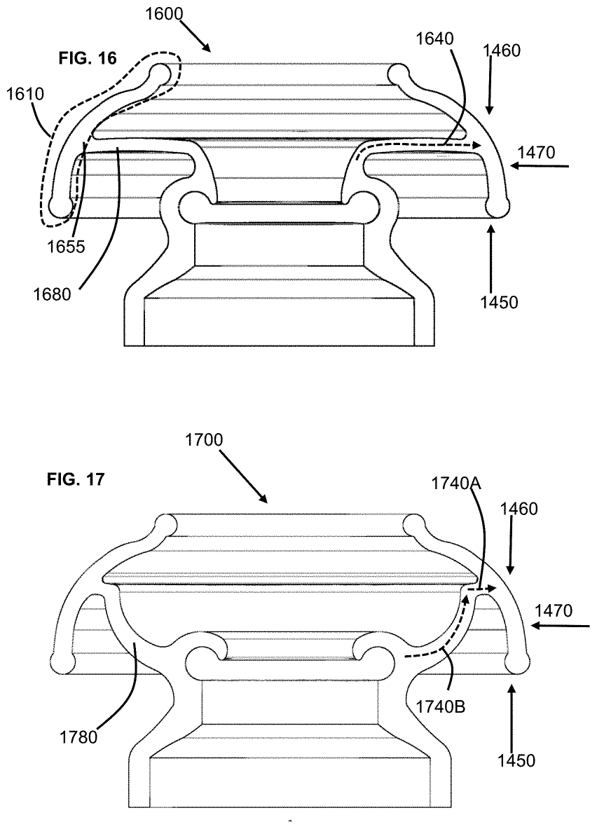

FIG. 16 illustrates a cross-section of a horizontal support eartip 1600, having a horizontal tip support 1680 that provides a force 1640 that opposes direct radial forces 1470 more so than distal forces 1460 or removal forces 1450. The horizontal structure provides a radial rigidity at the contact point 1655 of the tip support 1680 with the tip contact portion 1610, facilitating rotation about the contact point 1655. This allows the tip contact portion 1610 to rotate more easily about the contact point 1655 facilitating more contact area with the ear canal wall. For example if a radial force is applied ant-distally (toward ambient environment) of the contact point 1655, the tip contact portion will rotate counterclockwise about contact point 1655, bring more area to contact the ear canal and distribute forces, increasing comfort.

FIG. 17 illustrates a cross-section of a hybrid support eartip 1700. This eartip uses a hybrid tip support 1780 that uses a sweep forward tip support with a horizontal tip support providing a sweep forward force 1740B and a horizontal force 1740A. Designed to add more rigidity for insertion and rotation of the contact surface for comfort. Note that other combinations can be combined into a tip support, for example a sweep back, combined with a horizontal, and the discussion is not meant herein to limit tip support combinations.

Processes, techniques, apparatus, and materials as known by one of ordinary skill in the art may not be discussed in detail but are intended to be part of the enabling description where appropriate. For example, specific materials may not be listed for achieving each of the targeted properties discussed, however one of ordinary skill would be able, without undo experimentation, to determine the materials needed given the enabling disclosure herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions of the relevant exemplary embodiments. For example, if words such as “orthogonal”, “perpendicular” are used, the intended meaning is “substantially orthogonal” and “substantially perpendicular” respectively. Additionally, although specific numbers may be quoted in the claims, it is intended that a number close to the one stated is also within the intended scope, i.e. any stated number (e.g., 20 mils) should be interpreted to be “about” the value of the stated number (e.g., about 20 mils). Note also that each part of an eartip can be composed of different materials, for example the tip contact portion can be silicone, while the tip support composed of urethane and the stent also silicone or even a different material from the other parts.

Thus, the description of the invention is merely exemplary in nature and, thus, variations that do not depart from the gist of the invention are intended to be within the scope of the exemplary embodiments of the present invention. Such variations are not to be regarded as a departure from the spirit and scope of the present invention.

What is claimed is:

1. An eartip comprising:
a stent;
a tip contact portion; and
a tip support, wherein the tip support is connected between the stent and the tip contact portion, wherein the tip contact portion has a contact portion distal tip end that extents beyond a stent distal end, and wherein the tip support separates an interior of the eartip into a forward cavity and a rearward cavity.

2. The eartip according to claim 1, wherein the tip support is a sweep forward tip support.

3. The eartip according to claim 1, wherein the tip support is a sweep back tip support.

4. The eartip according to claim 1, wherein the tip support is a horizontal tip support.

5. The eartip according to claim 1, wherein the forward cavity is larger than the rearward cavity.

6. The eartip according to claim 1, wherein the tip support is a hybrid tip support including at least two of a sweep forward support, a sweep back support, or a horizontal support or a combination thereof.

7. The eartip according to claim 1 where the distance between the contact portion distal tip end and the a stent distal end is greater than 2 mm and less than 10 mm.

8. The eartip according to claim 7, wherein the stent is configured to include a recess, wherein the recess is configured to fit an earphone protrusion.

9. The eartip according to claim 8, wherein the eartip has an oval cross section.

10. The eartip according to claim 1, wherein the eartip is composed of a material having a shore A between 10 and 70.

11. The eartip according to claim 1, wherein the tip contact portion and a tip support have different shore A values.

12. The eartip according to claim 1, wherein the tip contact portion and the tip support are composed of different materials.

13. The eartip according to claim 1, wherein at least two of the tip contact portion, the tip support and the stent, are composed of different materials.
